(19) United States
(12) Patent Application Publication
(10) Pub. No.: US 2022/0026101 A1
(43) Pub. Date: Jan. 27, 2022

(54) SYSTEM AND METHOD FOR MULTI-ZONE CLIMATE CONTROL

(71) Applicant: Komfort IQ Inc., Los Angeles, CA (US)

(72) Inventor: John Ko, Los Angeles, CA (US)

(21) Appl. No.: 17/499,305

(22) Filed: Oct. 12, 2021

Related U.S. Application Data
(63) Continuation-in-part of application No. 16/040,579, filed on Jul. 20, 2018, now abandoned.
Application No. 16/040,579 is a continuation-in-part of application No. 17/326,496, filed on May 21, 2021.
(60) Provisional application No. 62/632,480, filed on Feb. 20, 2018.

(51) Int. Cl. F24F 11/81; F24F 11/35; F24F 11/63; F24F 11/88; F24F 7/06

(52) U.S. Cl. CPC F24F 11/81; F24F 11/35; F24F 2110/10; F24F 11/88; F24F 7/06; F24F 11/63

(57) ABSTRACT

An intelligent air management system comprises an HVAC unit, a smart duct comprising an electromechanically actuated damper, a power supply connected to the smart duct, a controller communicatively connected to the smart duct and at least one room sensor positioned in a room, and a vent fluidly connected to the smart duct and positioned in the room, wherein the controller is configured to open and close the electromechanically actuated damper in response to measurements from the at least one room sensor. A method of controlling room temperature in a multi-room structure is also described.

### CROSS-REFERENCE TO RELATED APPLICATIONS

This application is a continuation-in-part of U.S. patent application Ser. No. 16/040,579, filed on Jul. 20, 2018, now pending, which claims priority to U.S. Provisional patent application No. 62/632,480, filed on Feb. 20, 2018. This application also claims priority to U.S. patent application Ser. No. 17/326,496, filed on May 21, 2021, now pending, all of which are incorporated herein by reference in their entireties.

### BACKGROUND OF THE INVENTION

Currently available Heating, Ventilation, and Air Conditioning (HVAC) systems broadly fall into two categories. Smaller residential systems consist of a single “zone,” which has a heating system, an air conditioning system, and a thermostat. The thermostat measures the temperature at a single point in the residence, sometimes near the air intake for any recirculating ventilation system, and compares that temperature to a threshold or set of thresholds. If the temperature falls below a minimum threshold, the HVAC system will turn on the heater to warm the residence. If the temperature rises above a maximum threshold, the HVAC system will turn on the air conditioner to cool it.

A second category combines multiple such systems within a larger residential or commercial structure, partitioning the structure into “zones.” For example, an office building might be divided into four zones, each with its own thermostat, heater, and air conditioner. In this example, each zone will act like its own, closed, thermostatically-controlled system, with three settings (heat, cool, or do nothing) and one measurement point (the thermostat). Zones can vary widely in size, from fifty square feet to thousands of square feet.

These existing systems have numerous disadvantages. First, they are inefficient because they don't accurately read the temperature in different spaces within a zone. An office space might have a single thermostat positioned in a hallway, but not in any individual office. This can lead to a situation where an HVAC system continues to cool an already cool room because the thermostat happens to be located in a warmer part of the office. In another example, an office without windows on the north side of a building can have a significantly different temperature than a conference room with windows facing the south side of a building. In residential applications, rooms on the top floor of a house will often be significantly warmer than the basement, due to hot air's natural tendency to rise.

Zones in multi-zone HVAC systems are also inflexible, meaning that it is difficult to re-route air, and impossible to adjust ventilation pathways dynamically during the course of a day. Ducts and air handlers are placed during building construction, and so the only way to change their shape or to add more is to redesign and replace the existing ducts and controllers, an expensive and cumbersome process. Though ducts including motorized dampers exist, the existing ducts are not wirelessly connected or controllable, and any adjustments require the intervention of a building engineer, either manually adjusting one or more dampers or controlling them through a separate, wired control system.

Most ducts used by existing HVAC systems in homes and commercial buildings are “dumb,” i.e. they lack any sensors or actuators for providing measurements, controls, or interoperability with other ducts in the HVAC system. Dumb ducts are open tubes that move air around a system without any intelligence. As a result, they create an inefficient, imbalanced distribution of hot and cold air, making some areas colder when they are cool already and some areas hotter when they are already hot.

Thus, there is a need in the art for a more granular system of air circulation and climate control, with intelligent sensors and actuators to increase efficiency and overall comfort. The present invention satisfies that need.

### SUMMARY OF THE INVENTION

In one aspect, an intelligent air management system comprises an HVAC unit, a smart duct comprising an electromechanically actuated damper fluidly connected to the HVAC unit, a power supply connected to the smart duct, a controller communicatively connected to the smart duct and at least one room sensor positioned in a room, and a vent fluidly connected to the smart duct and positioned in the room, wherein the controller is configured to open and close the electromechanically actuated damper in response to measurements from the at least one room sensor.

In one embodiment, the system further comprises a supply plenum box and the smart duct is a smart supply duct. In one embodiment, the is the system further comprises a return plenum box and the smart duct is a smart return duct. In one embodiment, the room sensor is a temperature sensor. In one embodiment, the system further comprises at least one duct sensor positioned within the duct and communicatively connected to the controller. In one embodiment, the duct sensor is a smoke sensor, and the damper is configured to close automatically when smoke is detected in the duct. In one embodiment, the duct sensor is a heat sensor, and the damper is configured to close automatically when a very high temperature is detected in the duct. In one embodiment, the power supply is a wired electrical power supply. In one embodiment, the power supply is a battery. In one embodiment, the controller is a thermostat.

In one embodiment, the system further comprises a supply plenum box fluidly connected to the HVAC unit, a return plenum box fluidly connected to the HVAC unit, a smart supply duct fluidly connected to the supply plenum box and the vent, and a smart return duct fluidly connected to the return plenum box and the vent, wherein the vent can serve as a return vent when the smart return duct is open, or as a supply vent when the smart supply duct is open. In one embodiment, the system further comprises a VAV air handler.

In another aspect, a method of controlling room temperature in a multi-room structure, comprises the steps of obtaining a first room temperature measurement from a sensor in a first room, obtaining a second room temperature measurement from a sensor in a second room, activating an HVAC unit to change the temperature of air flowing through the HVAC unit, opening a first damper in a first smart duct fluidly connected to the first room, closing a second damper in a second smart duct fluidly connected to the second room, and forcing a quantity of air through the HVAC unit and the first smart duct into the first room, such that the closed second damper blocks substantially all air flow into the second room.

In one embodiment, the method further comprises the steps of obtaining a duct air flow measurement from an air flow sensor positioned within the first smart duct, comparing the duct air flow measurement to an expected first duct air flow level, and, if the duct air flow measurement is less than the expected first duct air flow level, opening a smart bypass duct fluidly connected to an intake of the HVAC unit. In one embodiment, the HVAC unit is an air conditioner configured to reduce the temperature of the air passing through it.

In another aspect, a method of controlling room temperature in a multi-room structure comprises the steps of obtaining a first room temperature measurement from a sensor in a first room, obtaining a second room temperature measurement from a sensor in a second room, obtaining a desired threshold air temperature, activating a fan to move air through an HVAC unit, opening a first damper in a first smart duct fluidly connected to the first room, opening a second damper in a second smart duct fluidly connected to the second room, and forcing a quantity of air from the first room through the HVAC unit into the second room when the first room temperature measurement meets the desired threshold air temperature and the second room temperature measurement does not meet the desired threshold air temperature.

In one embodiment, the method further comprises the steps of activating a cooling element within the HVAC unit to further cool the air, wherein the desired threshold air temperature is a maximum air temperature. In one embodiment, the method further comprises the steps of activating a heating element within the HVAC unit to further heat the air, wherein the desired threshold air temperature is a minimum air temperature. In one embodiment, the method further comprises the steps of opening a damper in a bypass duct fluidly connecting a supply side of the HVAC unit to the return side of the HVAC unit, and flowing a quantity of air through the bypass duct and back through the HVAC unit to be cooled further. In one embodiment, the method further comprises the steps of opening a damper in a bypass duct fluidly connecting a supply side of the HVAC unit to the return side of the HVAC unit and flowing a quantity of air through the bypass duct and back through the HVAC unit to be heated further.

In another aspect, a method of controlling room temperature in a room comprises positioning a plurality of room sensors in a room fluidly connected to an HVAC unit, each room sensor comprising a temperature sensor, periodically measuring and recording a temperature measurement from each of the plurality of temperature sensors, activating the HVAC unit, flowing conditioned air into the room, calculating a rate of change of temperature in the room while the HVAC unit is activated, deactivating the HVAC unit, stopping the flow of conditioned air into the room, calculating a second rate of change of temperature in the room while the HVAC unit is turned off, and controlling the HVAC unit with a calculated model of temperature change, configured to activate the HVAC unit for as long as necessary to maintain a set temperature in the room.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, and in which:

FIG. 1 is a diagram of an exemplary residential MicroZone system;

FIG. 2 is an overhead diagram of an exemplary commercial MicroZone system;

FIG. 3 is an exemplary connection diagram of a MicroZone system;

FIG. 4 is a diagram of an exemplary residential MicroZone system;

FIG. 5 is a diagram of an exemplary residential MicroZone system;

FIG. 6 is a diagram of an exemplary commercial MicroZone system;

FIG. 7 is a schematic of an exemplary smart duct.

FIG. 8 is a diagram of an exemplary distribution of smart ducts in a residential application;

FIG. 9 is a detail diagram of smart duct placement near an HVAC unit;

FIG. 10 is a connection diagram of an exemplary MicroZone system;

FIG. 11A is a perspective view of an exemplary room sensor;

FIG. 11B is a bottom view of an exemplary room sensor with a barrier;

FIG. 11C is a side view of an exemplary room sensor with a barrier;

FIG. 11D is a view of an exemplary barrier;

FIG. 11E is a view of an exemplary barrier;

FIG. 12A is a flow diagram of an algorithm of the present invention;

FIG. 12B is a flow diagram of an algorithm of the present invention;

FIG. 12C is a flow diagram of an algorithm of the present invention; and

FIG. 12D is a flow diagram of an algorithm of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G or 4G/LTE networks, Bluetooth®, Bluetooth® Low Energy (BLE), Bluetooth Mesh, Bluetooth Low Energy Mesh, Zigbee®, or Z-wave communication links, or any other method by which one electronic device is capable of communicating with another. In some embodiments, elements of the networked portion of the invention may be implemented over a Virtual Private Network (VPN).

As used herein, a “MicroZone System” or “MicroZone” is a system where airflow into each space in a HVAC zone can be independently controlled without the need for additional HVAC controllers. For example, a “space” in an HVAC zone can be a living or working space room, a hallway, conference room, or other space usually defined by partitions such as walls and doors. In some instances, a MicroZone may be a subsection of a larger room, for example one half of a gymnasium. The MicroZone allows precise control of airflow to areas smaller than a typical HVAC zone, heating or cooling each MicroZone independently of the other spaces in the HVAC zone. In this way, a MicroZone system may allow for more efficient and more effective equalization of temperature throughout one or more HVAC zones. It is also possible to independently affect the temperature in a single MicroZone by controlling airflow to the MicroZone and periodically reading temperature measurements from one or more MicroZone sensors.

As used herein, a “smart duct” is a duct or portion of a duct that includes an attached actuator and one or more dampers that are moved by the actuator to control airflow. In some embodiments, the smart duct further includes one or more printed circuit boards (PCBs) including for example a microprocessor or microcontroller and a wireless connection. Some smart ducts may also further comprise zero or more sensors for measuring parameters of the air flowing through the duct or the surrounding environment.

MicroZones typically include at least one smart duct that supplies or returns air to the HVAC system. A MicroZone may include one or more smart supply ducts, smart return ducts, bypass smart ducts, or a combination of two or more of these. Each MicroZone also typically includes at least one temperature sensor, the measurements of which are used by one or more controllers to drive air into or out of the MicroZone. Systems of the present invention may also include additional sensors of various types, connected via wired or wireless connections to the one or more controllers. Although smart ducts allow for enhanced control of airflow, a MicroZone system can be constructed with any combination of smart and dumb ducts. For example, it is possible to construct a MicroZone system using only one or more smart supply ducts, only one or more smart return ducts, or only one or more smart bypass ducts, with the remaining ducts in the system being dumb.

A controller of the present invention is configured to intelligently distribute hot or cold air to MicroZones, and to control the temperature in each MicroZone independently of other MicroZones and the existing HVAC zone. In some embodiments, a conventional thermostat may act as the controller, but in other embodiments the controller may also include additional sensors and processing elements. For example, a controller may include a microprocessor or microcontroller, communicatively connected to one or more communication transceivers. These communication transceivers may support one or more wired or wireless communication protocols, including but not limited to Bluetooth, Bluetooth Mesh, Bluetooth Low Energy, Zwave, Zigbee, wi-fi, Ethernet, USB, IR, or any other suitable communication protocol known in the art. In one embodiment, the controller uses the various communication interfaces to gather data from a set of at least one sensor, process the data received from the at least one sensor, and based on the processed data, send control signals to one or more air conditioning units, heaters, air handlers, or smart ducts in order to control air flow for each MicroZone.

In one embodiment, the controller may function as or include a hub, and may facilitate communication via one or more wired or wireless communication protocols among various components of a system of the present invention, including but not limited to one or more thermostats, one or more sensors, one or more HVAC units, one or more Variable Air Volume (VAV) air handlers or VAV boxes, one or more smart ducts, or one or more additional controllers. In some embodiments, some or all functions of a controller of the present invention may be performed by a device embedded in or incorporated into an HVAC unit, a VAV box, or a thermostat.

Each MicroZone may contain one or more sensors configured to gather relevant parameters about the MicroZone for use by the controller to control temperature and airflow. Examples of such sensors include, but are not limited to, temperature sensors, air quality sensors, air flow sensors, humidity sensors, motion sensors, CO₂ detectors, CO detectors, light sensors, smoke sensors, cameras, proximity sensors, microphones, near-field communication (NFC) sensors, load cells, or any other type of sensor that could be useful for controlling HVAC parameters. Sensors of the present invention may be positioned by themselves, or may alternatively be integrated into custom housings or the housings of existing elements of the system or the room. Exemplary sensors may be integrated into a thermostat or other control mechanism for the HVAC system, or may alternatively be positioned within a light switch, a light switch cover, a wall power outlet, a wall power outlet cover, a motion detector, a smoke detector, a CO₂ detector, a CO detector, a window frame, a door frame, a hinge, crown molding, a baseboard, a doorknob, a door, a television, a chair, a bed, a sprinkler head, or any other position within a room advantageous for taking the appropriate measurement.

In some embodiments, one or more of the MicroZone sensor measurements may be used by the controller to determine whether or not a person is present in the MicroZone. For example, a motion sensor may monitor movement within the MicroZone, or a sound sensor may measure sounds made by people within the MicroZone. When the controller determines that a person is detected within the MicroZone, the controller may adjust the air temperature or air distribution to compensate. For example, the controller may open one or more smart ducts leading into a MicroZone where a person has been detected, and close one or more smart ducts leading into a MicroZone where no person is detected. By doing so, the MicroZone system will prevent the system from cooling or heating an area of the HVAC zone that is not currently in use by the occupants.

Each MicroZone may have at least one sensor positioned within it, or alternatively multiple MicroZones may share one or more sensors. The sensor or sensors transmits measurements to the controller, either autonomously or on demand when a query signal or message is received from the controller. The controller then processes the measurements and compares them with user settings, to determine which actions to take, for example turning an air conditioner on or off, or opening or closing one or more smart ducts.

In one example, the top floor of a home is hotter than the bottom floor, as detected by temperature sensors placed on the top and bottom floors. If the controller is set to cooling, i.e. to maintain a temperature below a given threshold, the MicroZone system may close one or more smart ducts leading to the bottom floor and open one or more smart ducts leading to the top floor, while activating the air conditioner. In this way, the cool air from the air conditioner will be routed only to the top floor, where it is needed most. The system may additionally or alternatively open a smart bypass or smart recirculation duct, designed to recirculate air from the output of the air handler, or air conditioning unit back into the intake. In this way, the exhaust air that ultimately reaches the vents in the one or more micro zones will be cooler than it otherwise would have been, because longer exposure to the cooling elements leads to more heat being withdrawn. The system may additionally or alternatively open one or more smart return ducts on the bottom floor, drawing cooler intake air from the lower floors. The system may activate the air conditioning unit to further cool the air, or may alternatively simply vent the cooler air from the lower floor to the hotter upper floors without additional cooling. In this way, the system saves significant energy by running the air conditioner less when there is a ready supply of cold air accessible. It is understood that although the foregoing example describes cooling, the same system could work with heating if desired. The system may for example draw hot air from a higher floor for circulation to a lower floor if heating is needed.

In some embodiments, each zone has a return vent and a supply vent, but in other embodiments the vents may be shared by the supply and return ducts. For example, one vent in a MicroZone may have two air flow paths connecting it to the air handler, one at the exhaust and the other at the supply. One or more smart ducts then opens or closes to allow air flow via one path, but not the other.

In another example, an office space on the north side of a building may be naturally cooler in the afternoon than a conference room with south facing windows. The MicroZone system, with the HVAC set to cooling, can open one or more smart ducts that lead to the conference room while closing one or more smart ducts that lead to the office space on the north side of the building. This in effect creates MicroZones in the office space that work with a single controller but whose temperatures can be controlled independently of other MicroZones. The MicroZone system may alternatively draw cool air from the office space on the north side of the building, either to be cooled further or to be vented into the conference room to cool it down.

Smart ducts of the present invention may be manufactured similarly to currently available HVAC air ducts, and may thus easily be made compatible with existing HVAC systems. In some embodiments, the smart ducts may be made from steel or aluminum, though other materials, such as plastic, may also be used. Smart ducts may be made in any size or shape, and may be made to interlock with existing ducts in currently-available HVAC systems. Duct sizes include but are not limited to 4″ round, 20″ round, 10×14″ rectangular, 12×12″ rectangular, 10×22″ rectangular, etc. Smart ducts may include one or more dampers, controlled by one or more actuators and configured to constrict or increase airflow. The damper will in some embodiments be made of the same material as the surrounding duct, or may alternatively be made from a different material.

Smart ducts of the present invention may be modeled after any currently-available duct component, including but not limited to a connector duct that connects two separate ducts, a starting collar duct configured to facilitate transition from a plenum box or HVAC box to a round air duct, a saddle take off, a side take off, a top take off, or any other duct component.

The actuator may be any actuator suitable for moving a damper into position, including but not limited to a motor or a solenoid. The actuator may be any size, shape, speed, or power rating. In some embodiments, the actuator may include a gearing system for multiplying torque. In some embodiments, the actuator is configured to drive the damper to either a substantially closed position (constricting air flow through the duct) or a substantially open position (allowing air to flow freely through the duct). In other embodiments, the actuator may be configured to additionally hold the damper in one or more partially-closed positions, to allow for varying degrees of limited air flow through the duct. In some embodiments, the actuated damper may be configured to close automatically when power is disconnected.

Smart ducts of the present invention may further include one or more microcontrollers, microprocessors, or other processing means. The microcontroller may control the actuator for the damper in response to instructions received from a controller, and may additionally collect data from one or more sensors positioned on or around the smart duct. Sensors that may be used with a smart duct include, but are not limited to an airflow sensor, an air quality sensor, a temperature sensor, a humidity sensor, and a smoke detection sensor. An airflow sensor could be configured, for example, to monitor air flow through the duct to detect that the expected amount of air is flowing. The airflow sensor may also be used as a feedback when adjusting the air flow to meet manufacturer specifications for the duct or system.

An air quality sensor may be used for example to detect and report the quality of the air flowing through the duct. The air quality sensor may be used to notify users of good or bad air quality, and may further be used for example to indicate when an air filter in the HVAC system's intake should be replaced. A temperature sensor may be used to detect the temperature of the air flowing through the duct. This can be helpful for example in determining whether the heating or cooling element is providing exhaust air of an appropriate temperature, and may also be used to determine whether there is a fire or other heat event. In one embodiment, if a smart duct detects a very high temperature, indicating that there is a fire nearby, the smart duct will close so as to slow the spread of the fire. Similarly, a smoke sensor may be positioned in the duct to detect the presence of smoke, and a smart duct may be configured to close automatically when smoke is detected, so as not to circulate smoke to other areas in the HVAC zone. Finally, a humidity sensor of the present invention may be configured to detect the humidity of the air flowing through the duct. Humidity information can then be used to notify users of the humidity or to interact with other systems to adjust humidity of the recirculated air.

In some embodiments, a system may include one or more air quality sensors positioned in various rooms or zones, for example one air quality sensor in each room or zone. In some embodiments, an “air quality sensor” as disclosed herein may refer to a set of related air quality sensors, selected from a CO₂ sensor, a CO sensor, a volatile organic compound (VOC) sensor, a total volatile organic compound (TVOC) sensor, a particulate matter (PM) sensor, an NO₂ sensor, an NO sensor, an O₃ sensor, or an SO₂ sensor. In some embodiments, data measured from the various air quality sensors in the various rooms or zones may be used as inputs to an algorithm for opening or closing ducts, for example to maximize or improve air quality in various rooms in a building in addition to attaining a temperature set point. For example, where an air conditioning system has intake vents in multiple rooms and one room has particularly high PM levels, the intake vent in that room may be opened in order to draw the poor quality air through an air filter and improve overall air quality in the building. In other configuration, an intake vent in the room having the highest overall air quality may be opened in order to provide the highest quality conditioned air to other parts of the building.

In some embodiments, air quality sensors positioned in different rooms may additionally be configurable to monitor the cleanliness of various ducts in a building. For example if intake air in a system is drawn from a room known to have high quality air, and air quality drops in a target room after the conditioned, high quality air is vented into the target room, then the system may determine that one or more ducts between the room from which the intake air was drawn and the target room may have accumulated dust or debris and therefore may require cleaning. In some embodiments, air quality sensors in multiple rooms may be used in conjunction with air quality sensors external to a building, or geographic air quality data available on the Internet, to determine whether or how much to open dampers connected to fresh outside air. For example when air quality in one or more rooms in a building is low, but outside air quality is high, such dampers may be opened more in order to allow more external air into the system. Conversely, when internal air quality is high but external air quality is low, such dampers may be closed more in order to limit the flow of poor quality external air into the building.

A smart duct of the present invention may further include one or more wireless radios or wired connections, configured to communicate with the controller, a hub, a thermostat, a smartphone, the Internet, a remote controlling computer system, or other smart ducts. In some embodiments, each smart duct acts as a repeater for the wireless signals of other smart ducts, allowing for the formation of a mesh network and extending the range at which smart ducts may be placed from the controller, hub, thermostat, or Internet gateway. Exemplary communication messages sent to and from smart ducts include, but are not limited to sensor readings and control signals to direct the dampers open or closed.

Examples of smart ducts for use with a system of the present invention include smart supply ducts, smart return ducts, smart bypass ducts, smart smoke ducts, and smart fire ducts. A smart supply duct can be used for example to intelligently distribute air to spaces that require warm or cool air from the HVAC system. Working with other smart ducts, each supply duct can dynamically control the flow of air that goes to each MicroZone, cooling or heating MicroZones that need it and inhibiting wasteful airflow into any MicroZone that doesn't. For example, if a home has two floors and the top floor is warmer than the bottom floor when the HVAC is in cooling mode, a smart supply duct can restrict cold airflow into the bottom floor and open airflow into the top floor. This will more efficiently cool the home and better equalize the temperature throughout the home.

A smart return duct intelligently controls the airflow into the HVAC system. In one example, the air in the top floor of a home is hotter than the air in the bottom floor, and the HVAC is set to cooling. In this example, a smart return duct can intelligently choose to draw air from the bottom floor and, working with a smart supply duct, expel it to the top floor helping to save energy and equalize the temperature throughout the home more efficiently.

A smart bypass duct allows supply air to be directed to the return of the HVAC system. HVAC manufacturers require proper airflow in cfm (cubic feet per minute) to ensure proper operation of the HVAC system. Smart bypass ducts can be used to help control this airflow and allow for more efficient cooling or heating of the air, as already-heated or cooled air is returned directly into the HVAC system for further heating or cooling. Smart bypass ducts can also be intelligently controlled by measuring the airflow in the smart supply ducts. For example, if the smart supply ducts do not detect enough airflow per the manufacturers specifications, one or more smart bypass ducts can be opened or adjusted to facilitate proper airflow through the HVAC system.

A smart smoke duct has a smoke detection sensor that detects the presence of smoke in the air that is passing through the duct. Upon detection of a large amount of smoke, the smart smoke duct closes, preventing the return or supply of the smoke into and out of the HVAC system. Similarly, a smart fire duct has a temperature sensor that reads the temperature of the air flowing through the duct. When the smart fire duct detects an extremely high temperature, the smart fire duct closes, preventing the return or supply of fire or extremely hot air through the HVAC system or to the HVAC zone.

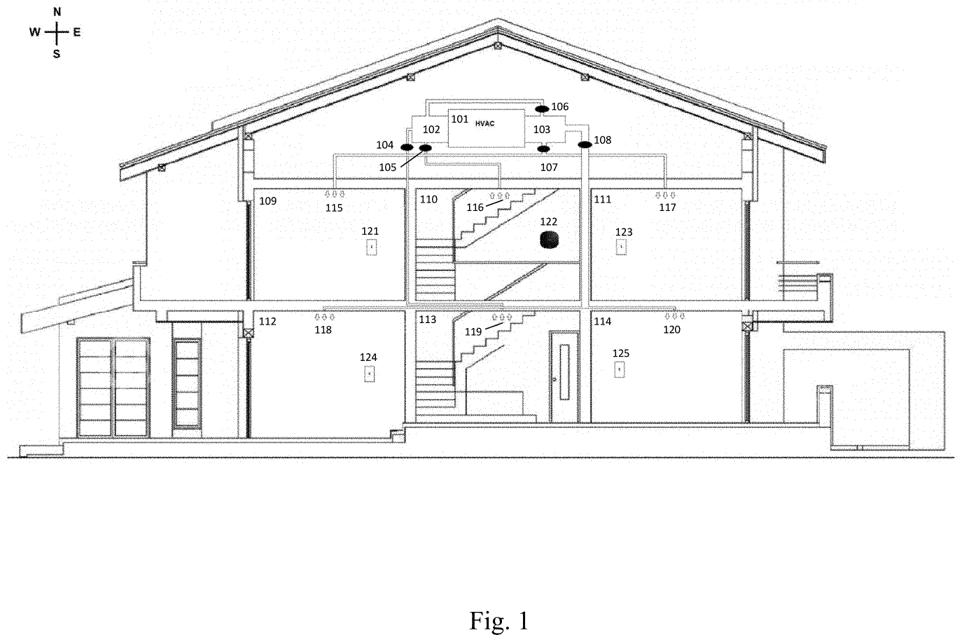

With reference now to FIG. 1, an exemplary diagram of a residential MicroZone HVAC system is shown. HVAC system 101 is positioned in the attic or top floor of the home, fluidly connected to return plenum box 102 and supply plenum box 103. Smart return ducts 104 and 105 regulate flow from vents 116 and 119 (positioned in rooms 110 and 113), respectively, into return plenum box 102. Smart supply duct 107 regulates flow from supply plenum box 103 into vents 115 and 117, located in rooms 109 and 111 respectively. Similarly, smart supply duct 108 regulates flow from supply plenum box 103 into vents 118 and 120, positioned in rooms 112 and 114, respectively. The system shown in FIG. 1 further comprises a smart bypass duct 106, which when opened allows some air from supply plenum box 103 to recirculate back into return plenum box 102. In the exemplary embodiment, the system is controlled by a controller included with thermostat 122, but also gathers data from sensors 121, 123, 124, and 125 positioned in other rooms in the house. In this way, although the house would normally include only a single HVAC zone, the addition of the MicroZone control system and smart ducts allows the house to be divided into several, independently-controllable MicroZones.

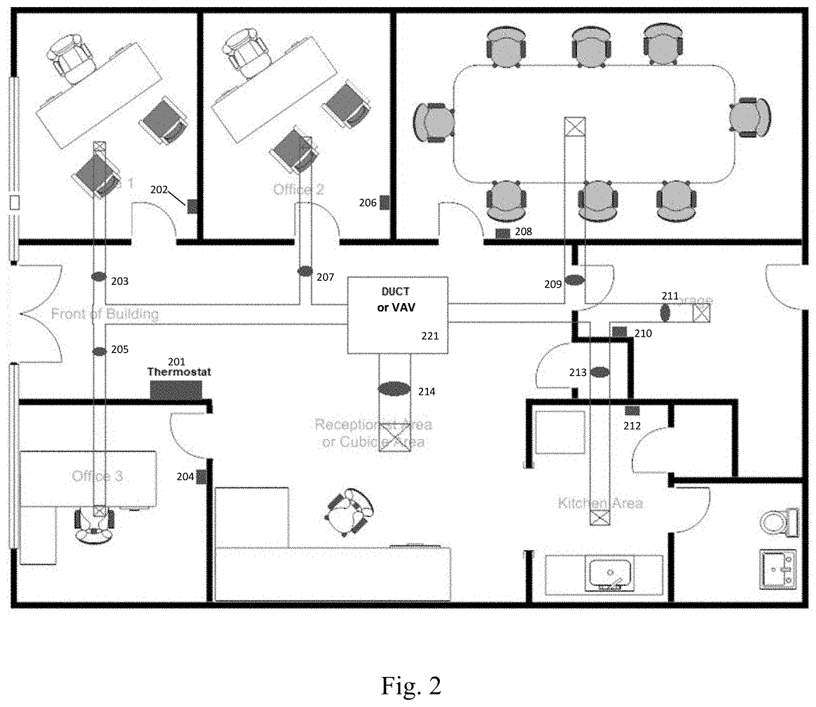

With reference now to FIG. 2, an exemplary diagram of a commercial MicroZone HVAC system is shown in an overhead view. Thermostat 201 is positioned near the front of the office, but several sensors 202, 204, 206, 208, 210, and 212 are located in rooms throughout the office space. In this embodiment, smart ducts 203, 205, 207, 209, 211, 213, and 214 are all smart supply ducts, as the HVAC system itself is located elsewhere in the building. In the example of FIG. 2, the various smart ducts open and close to allow or restrict the supply of air into the various offices and rooms depending on the temperatures measured by the various sensors. Some or all of the smart ducts in the system of FIG. 2 may be fluidly connected to a central duct 221, and/or may alternatively be fluidly connected to a VAV box.

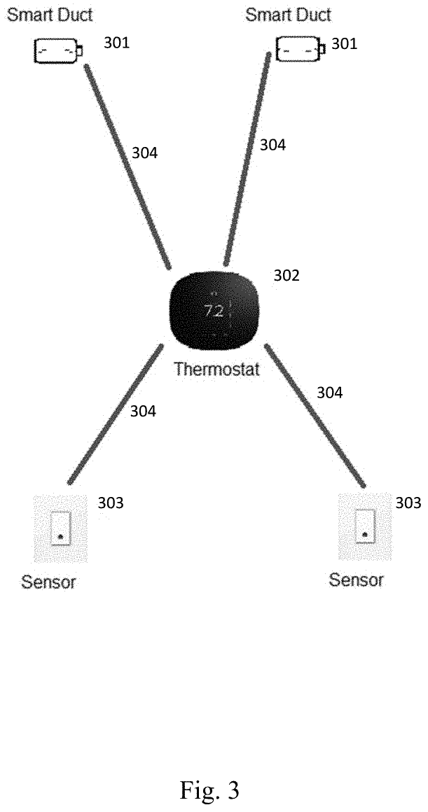

With reference to FIG. 3, a connection diagram of a system of the present invention is shown. In this exemplary embodiment, the MicroZone system comprises two sensors 303 and two smart ducts 301. Each sensor and smart duct is connected to the thermostat 302 via a wireless connection 304.

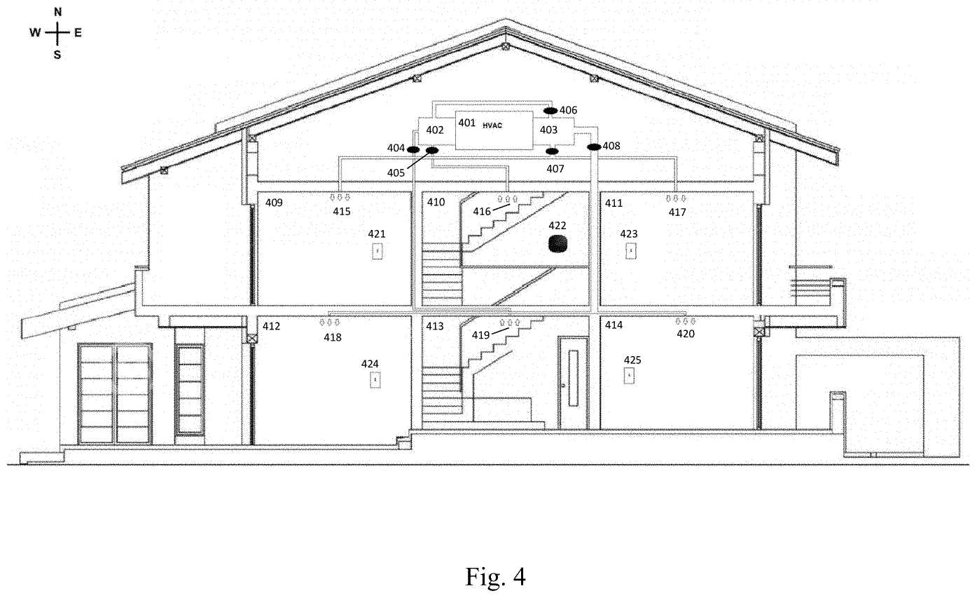

The behavior of a MicroZone system in two exemplary situations may be illustrated with reference to FIG. 4. In the first situation, the sensors on the second floor of a home 421 and 423 detect that the second floor is warmer than the first floor of the home, and the system is set to cooling (i.e. to maintain the temperature in the entire home below a set threshold). In this first example, the MicroZone system pulls air from the second floor of the home using the second floor return vent 416 (by opening smart duct 405) where the sensor 422 detects that the air is warmer. The air from return vent 416 gets pulled into return plenum box 402 and HVAC system 401, where it is cooled and supplied to rooms 409 and 411 using supply air vents 415 and 417. In this example, the first floor smart return duct 404 and the first floor smart supply duct 408 are both closed, because the first floor is already at the desired temperature. Opening the smart bypass duct 406 may further increase system efficiency, as air is cooled further by taking multiple trips through HVAC unit 401. In this way, the MicroZone system more efficiently cools a home by cooling only those areas that need cooling and not cooling the entire house.

In a second situation, the second floor of a home is warmer than the first floor of a home, but the system is set to heating (i.e. maintain the temperature in the entire home above a set threshold). In this second example, the MicroZone system pulls air from the second floor and/or the first floor of the home using the second floor return vent 416 (by opening second floor smart return duct 405) and first floor return vent 419 (by opening first floor smart return duct 404). The air is then heated by HVAC unit 401 and supplied to rooms 412 and 414 on the first floor using supply air vents 418 and 420 (by opening first floor smart supply duct 408). Smart supply duct 407 is closed, so that none of the supply air from the supply plenum box 403 gets distributed to the top floor rooms 409 and 411, because those rooms are already warm. Smart bypass duct 6 may also be opened to increase the efficiency of the HVAC system. In this way, the MicroZone system more efficiently heats the whole home to a uniform temperature.

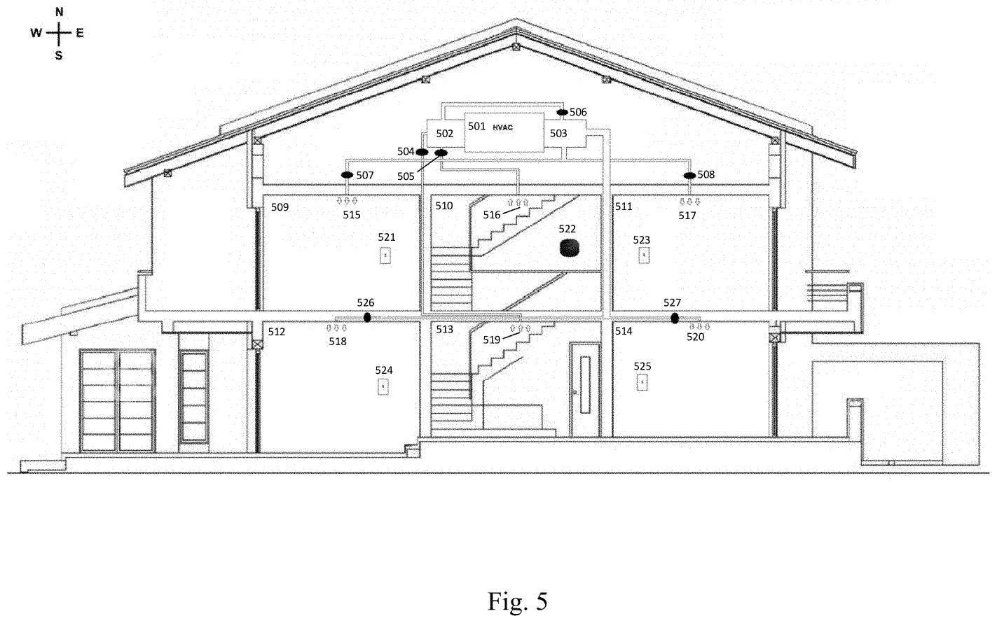

Two further examples may be illustrated with reference to FIG. 5. In the first example, rooms 511 and 514 on the east side of a house are warmer than rooms 509 and 512 on the west side of the house, and the system is set to cool. In this example, air is pulled from return vents 516 and 519 on the first and second floors by opening smart return ducts 504 and 505. The air is pulled into the HVAC system 501 where it is cooled and supplied to rooms 511 and 514, through supply vents 517 and 520, by opening smart supply ducts 508 and 527. Smart supply ducts 507 and 526 are closed, preventing cooled air from flowing into the west facing rooms 509 and 512. Thus, the system is able to operate more effectively by cooling only those rooms that are too warm.

In a second example, rooms 511 and 514 on the east side of a house are warmer than rooms 509 and 512 on the west side of the house, and the system is set to heat. In this example, the system pulls air from the first and second floors of the home using first and second floor return vents 516 and 519. The air is heated in HVAC system 501 and suppled to rooms 509 and 512 through supply vents 515 and 518, by opening smart supply ducts 507 and 526. Smart supply ducts 508 and 527 are closed, meaning that none of the heated air will flow to rooms 511 and 514, which are already sufficiently warm.

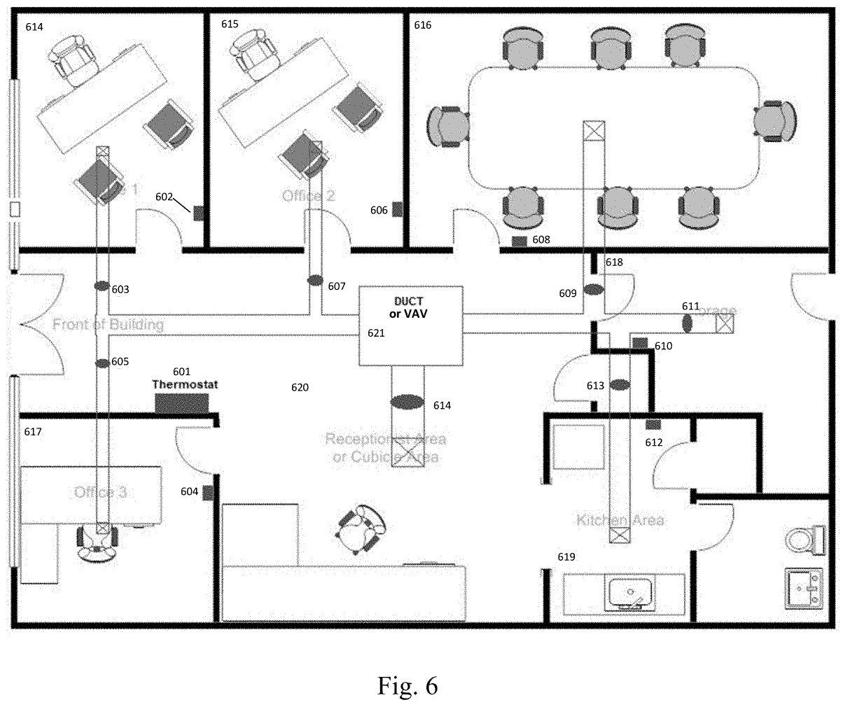

Two further examples of commercial applications may be illustrated with reference to FIG. 6. In the depicted example where the system is set to cool, the MicroZone system will return air to rooms where the temperature is warmer than the thermostat set temperature. Ducts that lead to rooms that are near or below the thermostat set temperature will be closed to maintain the temperature near or below the thermostat set to temperature.

In the first example, the north facing rooms 614, 615, and 616 are warmer than the south facing rooms 617 and 619, and room 620 has a temperature near the thermostat set temperature.

In a typical office environment, there are no return vents or return ducts within the office. By closing supply ducts where the temperature is at or below the set temperature, higher levels of efficiency can be achieved. Because the north facing rooms are warmer than the desired temperature, as measured by sensors 602, 606, and 608, the smart supply ducts 603, 607, and 609 that lead to those rooms are opened to allow cooled air into the rooms. Because rooms 617 and 619 are already sufficiently cool, as detected by sensors 604 and 612, the MicroZone system closes smart supply ducts 605 and 613 to prevent cooled air from the central duct or VAV 621 from further cooling rooms 617 and 619. The smart supply duct 614 leading to room 620 is also closed, because the temperature in room 620 is near the desired temperature. If the temperature in any of these rooms increases above the desired temperature, the corresponding smart supply ducts leading to those rooms is opened, in order to cool the rooms until the desired temperature is reached. In this way, the MicroZone system is capable of dynamically controlling the temperature in each MicroZone.

In a second example, where the system is set to heating, the MicroZone system will supply air to rooms where the temperature is cooler than the thermostat set temperature. Ducts that lead to rooms that are above or near the thermostat set temperature will be closed to maintain the temperature above or near the thermostat set temperature. The north facing rooms 614, 615, and 616 in the second example are cooler than the south facing rooms 617 and 619 and room 620 has a temperature near the thermostat set temperature. The smart supply ducts 603, 607, and 609 that lead to rooms 614, 615, and 616 are opened to allow warmer air into the room. Smart supply ducts 605 and 613, leading to rooms 617 and 619, and closed to prevent warmer air from further warming the rooms. Smart supply duct 614, leading to room 620, is also closed because the temperature is near the desired temperature. If the temperature in any of these rooms falls below the desired temperature, the smart supply ducts leading to those rooms are opened in order to warm the room until the desired temperature is reached.

A MicroZone system of the present invention may further comprise a Variable Air Volume (VAV) air handler or VAV box. In some HVAC systems, particularly multi-unit HVAC systems, a single large HVAC unit is used to provide conditioned air to multiple zones in a building. Some embodiments of the present invention include a VAV box in addition to an HVAC unit, while in other embodiments, some or all of the functions otherwise performed by the HVAC unit for the purposes of the invention (for example, providing conditioned air, consuming unconditioned air) are instead effectively performed by the VAV box. In some embodiments, the VAV box is controlled by the controller, while in other embodiments the VAV box is controlled independently from the system of the present invention. As used herein, an “HVAC component” may refer to any component of an air handling system configured to direct airflow, including but not limited to an air handler, fan, HVAC unit, VAV box, damper, or vent.

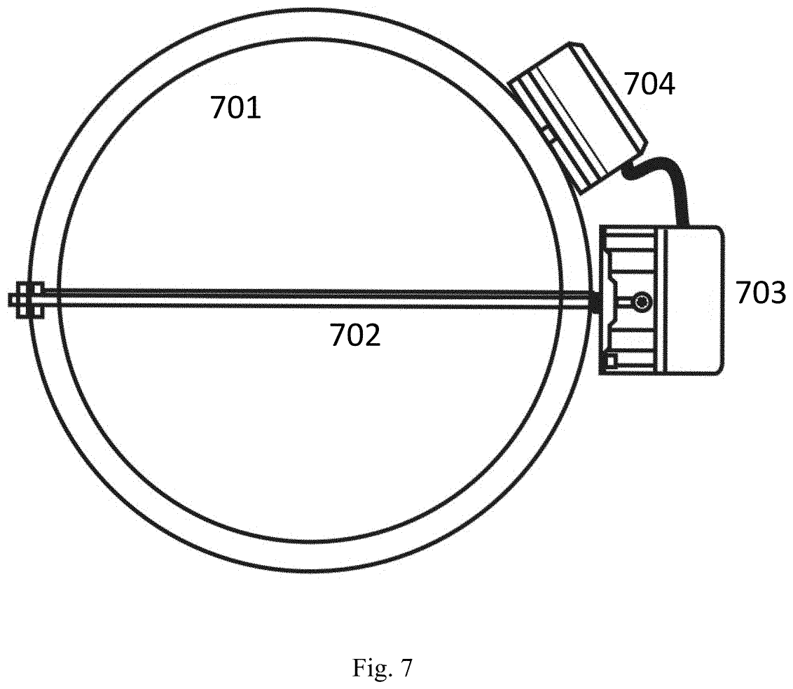

Referring now to FIG. 7, an exemplary diagram of a smart duct of the present invention is shown. The main structure is defined by the duct outer cover 701, which in this example is circular but could also be any other shape suitable for use with other ducts. The damper 702 advantageously has substantially the same shape and size as the inner profile of the duct outer cover 701, so that when the damper 702 is in the fully closed position, it blocks substantially all air flow through the smart duct. The damper is controlled by actuator assembly 703, which in the depicted example operates by rotating the damper into an opened or closed position. The actuator is controlled by controller 704, which includes in some embodiments a PCB including a microcontroller and wireless communications. Controller 704 may be powered from existing electrical wiring within the building, or may alternatively include a battery for powering itself and the actuator assembly.

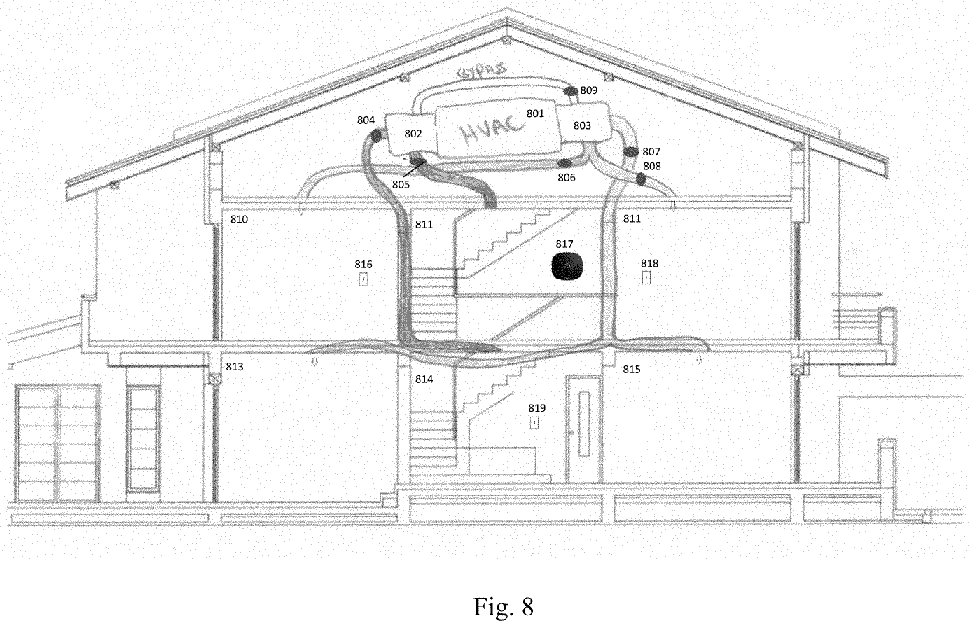

Referring now to FIG. 8, an exemplary diagram of smart duct positioning within a house is shown. Smart ducts 804 and 805 are fluidly connected to return plenum box 802, and so control the supply of return air to the HVAC system. Smart ducts 806, 807, and 808 are fluidly connected to supply plenum box 803, and therefore control distribution of supply air from the HVAC unit 801. Each smart duct may control air flow to one room or to multiple rooms. For example, smart duct 808 controls supply air flow only to the vent in room 812, whereas smart duct 807 controls supply air flow to both rooms 813 and 815. Smart duct 809 is a smart bypass duct, allowing for supply air to be recirculated back to the return plenum box.

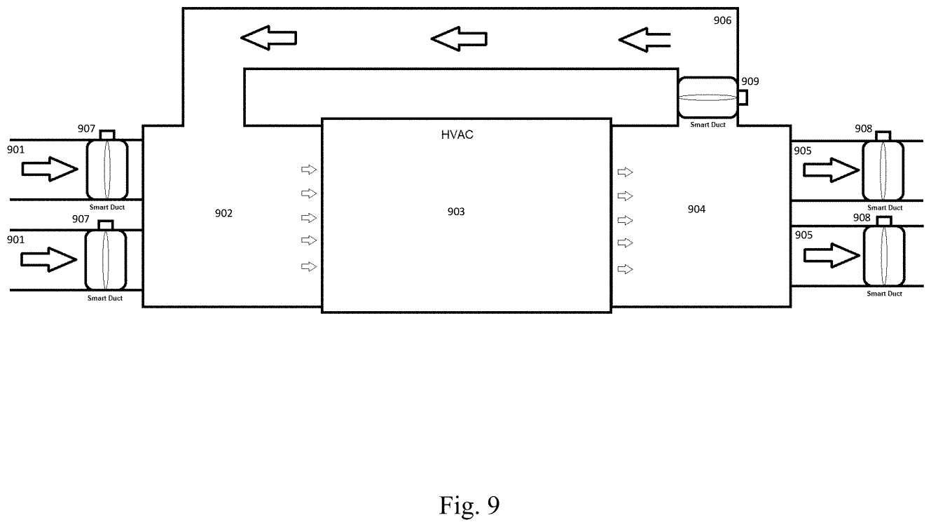

A detail view of smart duct placement is shown in FIG. 9. The flow of air is controlled into the return plenum box 802 by smart return ducts 807. The HVAC 803 will then heat or cool the air (or move air using the fan setting of the HVAC without cooling or heating the air) and send the air to the supply plenum box 804. From there, the smart bypass duct 809 and smart supply ducts 808 control the flow of air (heated, cooled or neither) to the various MicroZones and/or rooms of a home or office.

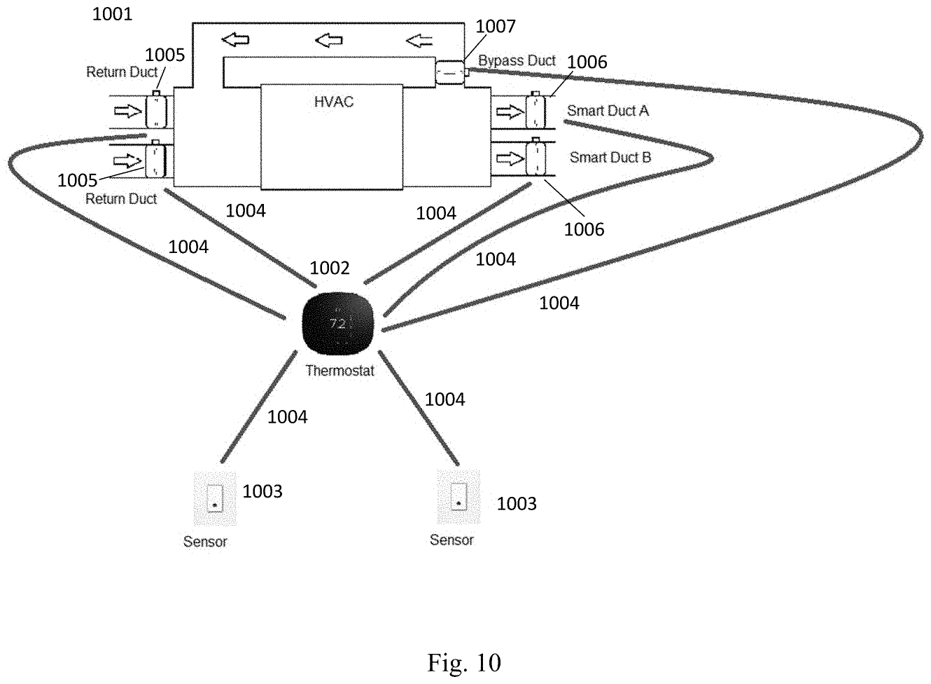

With reference to FIG. 10, a connection diagram of an exemplary smart duct system is shown. Smart ducts 1005, 1006, and 1007 are installed as part of an HVAC system 1001. The smart ducts and sensors 1003 are communicatively connected to thermostat 1002, which acts as the controller. The smart ducts, sensors, and thermostat are connected to one another via connections 1004, some or all of which may be wired or wireless connections.

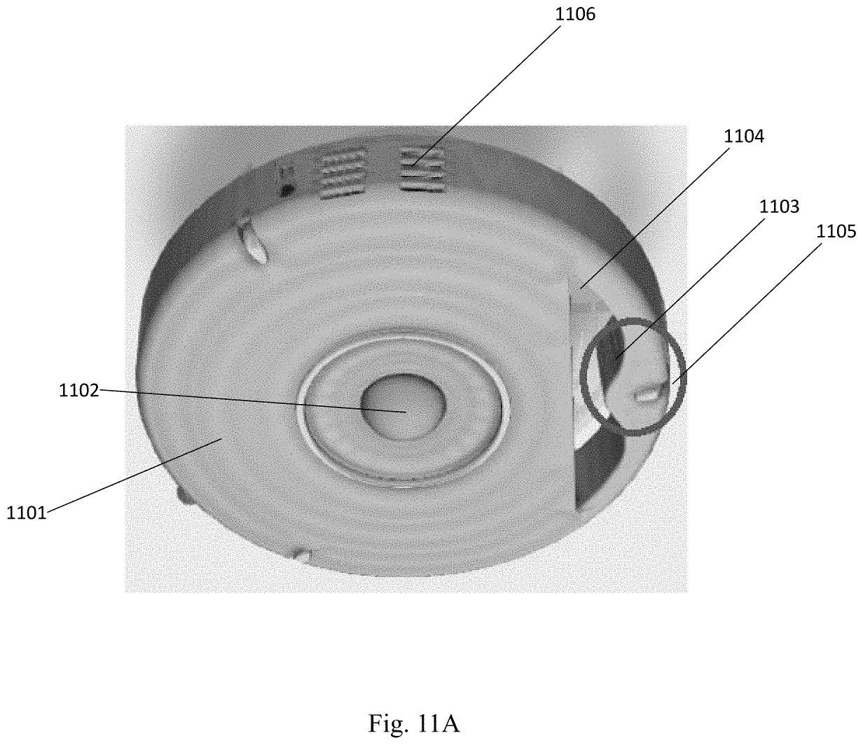

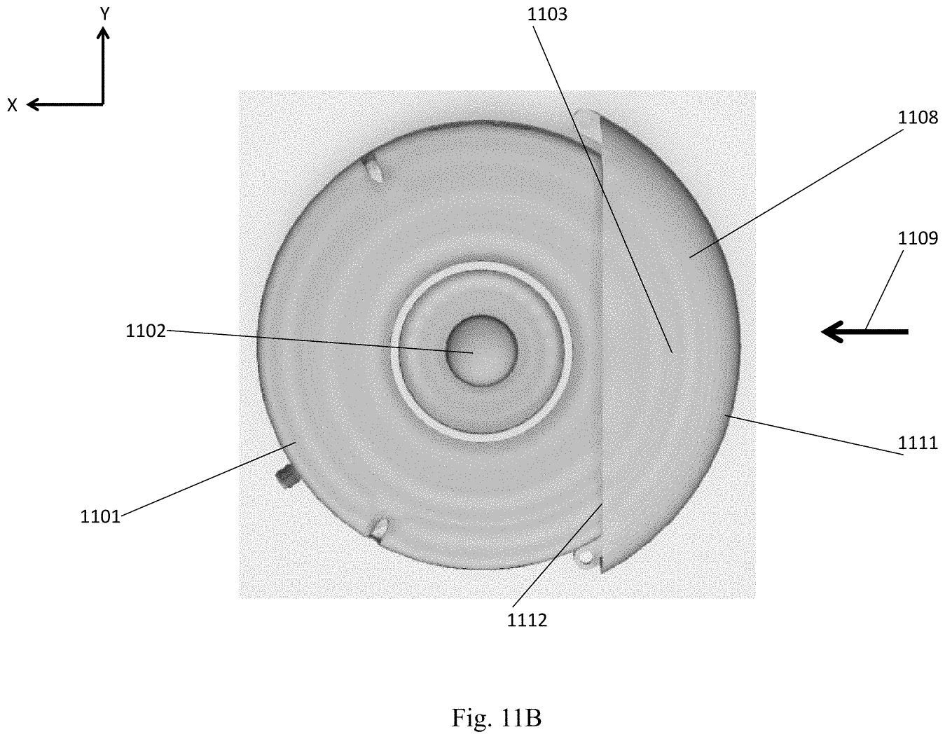

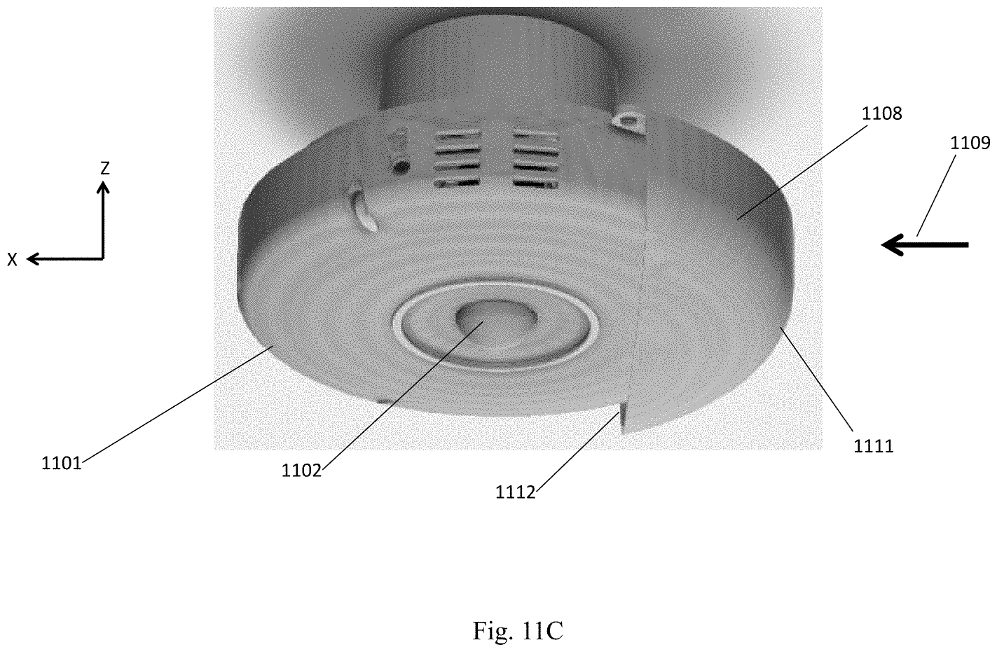

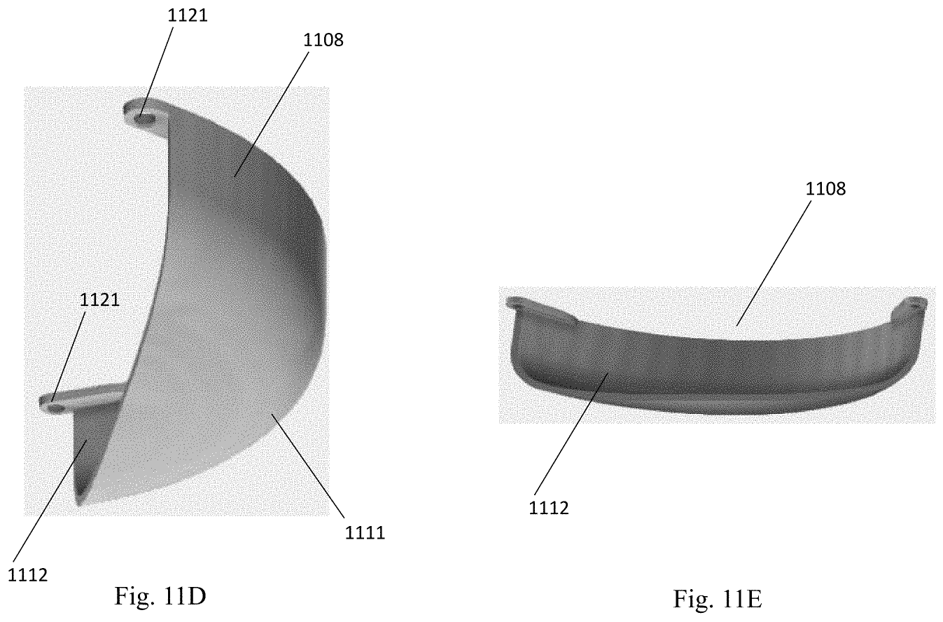

With reference to FIG. 11A, an exemplary room sensor of the present disclosure is shown. The depicted room sensor comprises a housing 1101, a central motion or presence sensor 1102, and a temperature sensor 1103, which in the depicted embodiment is positioned inside the housing 1101 near a wall 1105 of the housing 1101. The housing in some embodiments may include one or more windows, for example clear window 1103. The depicted window 1103 is positioned between the motion sensor 1102 and the temperature sensor 1103 in the housing.

In some embodiments, a temperature sensor may be positioned within a housing 1101 behind a vent, for example vent 1106 or a similar vent positioned in a wall of a housing 1101. In some embodiments, vent 1106 may be configured to allow for flow of ambient air within a room to pass over temperature sensor 1103. In some embodiments, a room sensor may comprise a printed circuit board (not shown) fixedly mounted within the housing. The printed circuit board may be configured to provide power to the one or more sensors, and may also comprise one or more communication links between the one or more sensors and a controller, for example a microcontroller or other embedded computing device. Although the room sensor depicted in FIG. 11A is circular, it is understood that a room sensor as contemplated herein could have any suitable shape, including square, triangular, hexagonal, or the like.

In some embodiments, a printed circuit board positioned within a room sensor may comprise an air gap or other slot, hole, or discontinuity in the printed circuit board (shown through the window in depicted embodiment). The discontinuity may be configured for example to thermally isolate the temperature sensor 1103 from heat generated by other components positioned on the printed circuit board, for example a microcontroller or wireless transceiver. In some embodiments, a room sensor may comprise an antenna for a wireless transceiver, for example positioned on the printed circuit board, positioned within the housing, positioned external to the housing, or partially or fully molded into the housing.

A room sensor as depicted in FIG. 11A may have issues in certain configurations positioned within rooms, for example when the room sensor is positioned adjacent to or in the air flow path of a vent. In such situations, conditioned air (e.g. cooled air or warmed air) blowing directly on the temperature sensor 1103 may skew the measured temperature, leading a controller to believe that the ambient temperature in the room in which the room sensor is positioned is actually lower or higher than the true ambient temperature at other points in the room. This situation may arise for example when positioning a room sensor at a more appropriate position may be difficult or impossible, for example where obstructions or other room geometry may prevent it, for example smoke detectors, plumbing infrastructure, electrical infrastructure, cross beams, or simple lack of suitable areas to mount equipment such as the disclosed sensor (e.g. open work/office environments), natural lighting systems, etc. In some embodiments, small offices sometimes do not have the space to place sensors far enough away from vents. In some embodiments, such situations may arise due to errors by installers or contractors, or failure to follow directions.

One solution to the problem of skewed temperature measurements is to position a barrier outside the housing 1101, blocking direct airflow to temperature sensor 1103. One exemplary barrier 1108 is shown FIG. 11B, which depicts a bottom view of a suitable room sensor. The depicted barrier is configured to impede or prevent flow of air travelling in a direction 1109 from reaching the temperature sensor 1103. In some embodiments, barrier 1108 comprises a structure having an outer face 1111 and an inner face 1112, with the outer face having a curved or angled structure configured to direct conditioned air around the room sensor 1101 and away from temperature sensor 1103. The barrier 1108 is still open on inner face 1112, to allow for ambient air within the room to reach the temperature sensor 1103, which in turn allows for a more accurate measurement of ambient temperature within the room or zone.

A side view of an exemplary barrier 1108 is shown in FIG. 11C. In addition to being curved in the x-y plane as shown in FIG. 11B, the barrier 1108 may also be curved in the x-z plane, for example curved to direct air downward (negative z axis as referenced in FIG. 11C) and away from the housing of the room sensor, toward the floor of the room (where the room sensor is ceiling-mounted). In some embodiments, the barrier 1108 may be connected to the room sensor, for example via a clip or fastener, for example a screw, or may alternatively be connected to the room sensor 1101 via an adhesive or other means. In some embodiments, the barrier 1108 is a separate structure configured to be mounted to the ceiling of the room adjacent to the room sensor 1101, for example via one or more fasteners or an adhesive. Standalone views of an exemplary barrier 1108 are shown in FIG. 11D and FIG. 11E, with the inner face 1112 visible. The depicted barrier 1108 includes two mounting holes 1121 which may be used for example to affix the barrier 1108 either to the ceiling adjacent to the room sensor or to the room sensor itself, for example using an adapter bracket.

In one embodiment, a system as disclosed herein may include a computing device configured to assist in creating a mesh network among a plurality of sensors and controllers as disclosed herein. The mesh network assist device may comprise one or more wireless transceivers, for example Bluetooth, Bluetooth Low Energy (BLE), Wi-Fi, ZigBee, or other transceivers configured to communicate with transceivers on one or more of the sensors and controllers. In some situations, a system may need to be adaptable to a variety of office layouts or floorplans, which can make it difficult or impossible to set up a mesh network using only the built-in functionality of the devices being added to the mesh. In some embodiments, a mesh network may be formed by carrying a portable mesh network assist device around to each of the sensors and controllers to be added to the mesh network and scanning/pairing the mesh network assist device with each of the sensors/controllers individually, for example using a wireless communication protocol, scanning a QR code or bar code with a camera, or any other proximity-based communication protocol. After the mesh network assist device has individually paired with or collected relevant information about each of the sensors and controllers, the mesh network assist device, with or without the assistance of an external computing device such as a remote server, may then be configured to create the mesh network among the individual component devices by communicating a new configuration to one or more of the individual components in the mesh. Relevant information about the sensors and controllers may include, but not be limited to, communication protocols used, hardware address(es), polling interval, location relative to one or more other sensors and controllers in the mesh, and the like.

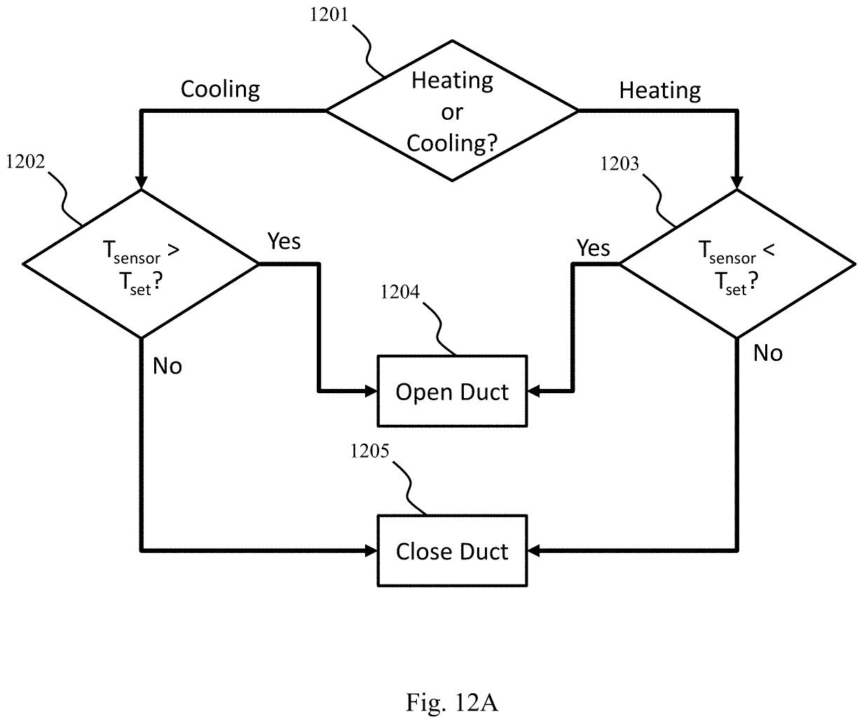

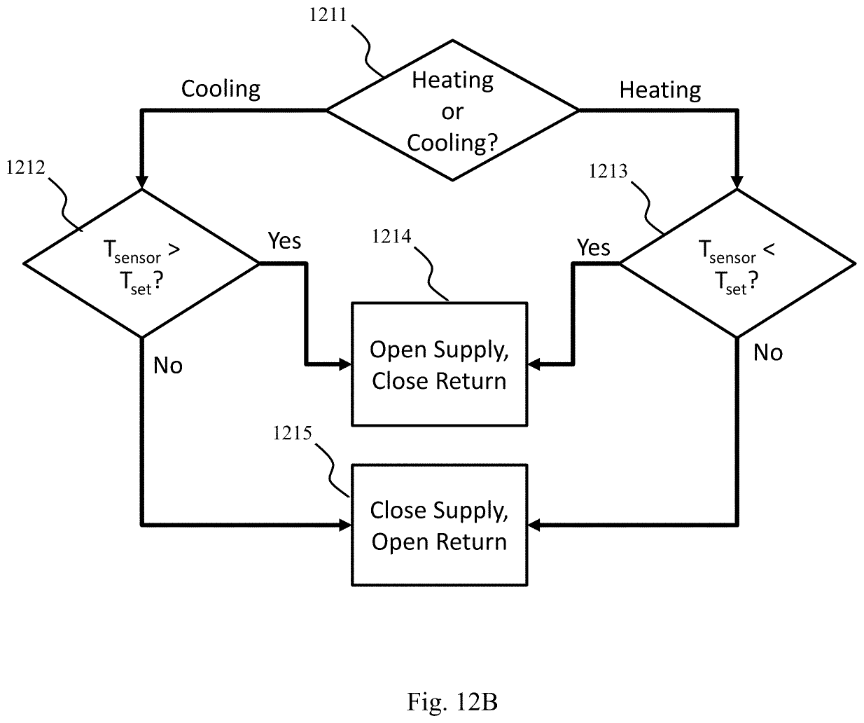

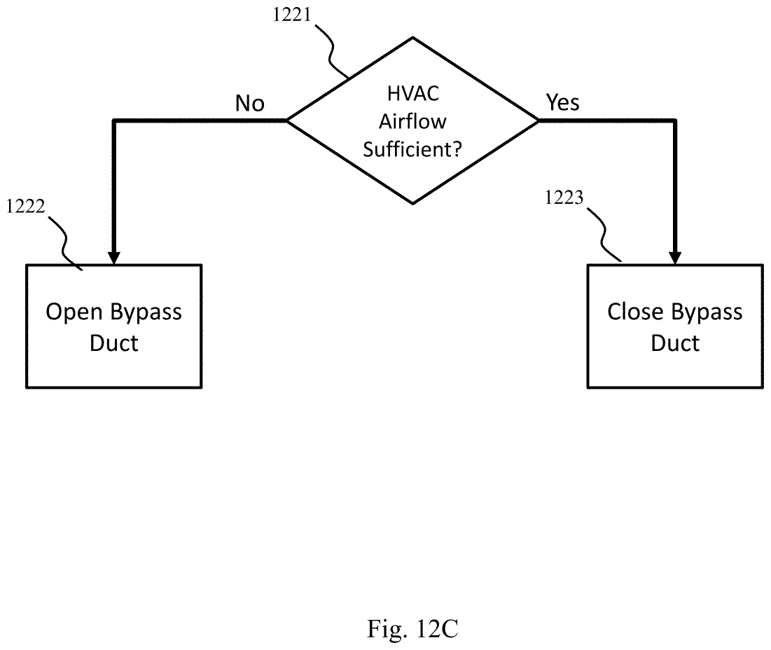

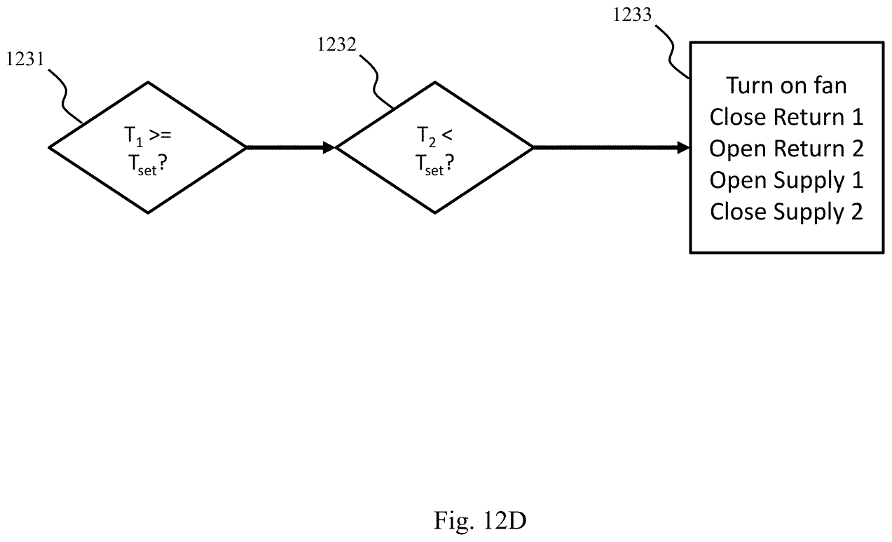

FIG. 12A-FIG. 12D show various controlling algorithms of the present invention. Referring now to FIG. 12A, in a system with supply vents and ducts in a set of MicroZones, each MicroZone may independently execute the depicted algorithm. First, the system will decide based on the setting at the thermostat whether the HVAC is heating or cooling at step 1201. If the system is set to cooling, the MicroZone will compare (step 1202) Tₛₑₙₛₒᵣ, i.e. the temperature measured at a sensor positioned within the MicroZone, to Tₛₑₜ, i.e. the temperature set at the thermostat or within the main HVAC control system. If Tₛₑₙₛₒᵣ>Tₛₑₜ, the controller will open the supply duct into the MicroZone (step 1204). If not, the controller will close the supply duct (step 1205). The corresponding opposite behavior is shown on the heating side of the diagram. By performing these steps independently in each MicroZone, a building with multiple MicroZones can conserve energy by directing conditioned air only to those areas of the building that need it.

Referring now to FIG. 12B, an alternate algorithm is shown, suitable for use in a system in which each MicroZone has both supply and return vents and ducts, or a single vent connected to both supply and return ducts, that may therefore be used as either a supply or return vent. The decision tree is similar to that of FIG. 12A, but in FIG. 12B, where Tₛₑₙₛₒᵣ>Tₛₑₜ, the supply duct is opened and the return duct is closed (step 1214). Where Tₛₑₙₛₒᵣ<=Tₛₑₜ, the supply duct is closed and the return duct is opened (step 1215). The HVAC system can therefore draw return air from those areas of the building that are already cold, cool it down further in the HVAC system, and supply the cooled air to areas of the building that are hot. The hotter rooms will therefore cool down more quickly, leading to savings in energy, time, and cost.

Referring now to FIG. 12C, an exemplary bypass duct algorithm is shown. The bypass duct algorithm of FIG. 12C can in some embodiments run in parallel to the duct control algorithms of FIG. 12A, FIG. 12B, or FIG. 12D. The bypass duct algorithm first checks to see if the air flow through the HVAC system is sufficient in step 1221. If it is, the bypass duct will close 1223. If the air flow is not sufficient, the bypass duct will open 1222, recirculating some supply air back into the return plenum of the HVAC unit.

Referring now to FIG. 12D, an alternative algorithm for energy saving is shown where a building has large temperature differences among the various MicroZones. In the algorithm of FIG. 12D, the controller measures temperatures T₁ and T₂ (in rooms 1 and 2 respectively), and compares both measurements to Tₛₑₜ. If T₁>=Tₛₑₜ (step 1231), and T₂<Tₛₑₜ (step 1232), that means that room 1 is hotter than the set temperature, but room 2 is colder than the set temperature. The system then redistributes the air among the MicroZones as described in step 1233, closing the return in room 1 and opening the supply, while closing the supply in room 2 and opening the return, and turning on the HVAC fan. Advantageously, the MicroZone system can use this method to cool a room with a fan alone, using far less power than would be necessary to power the compressor for an air conditioning unit. As with the other algorithms, the algorithm of FIG. 12D may also be used to heat a space that is colder than a set temperature by redistributing air from a warmer room, simply by reversing the signs on the comparisons in steps 1231 and 1232.

In some embodiments, a system as disclosed herein may further include one or more machine learning models executed on a computing device or processor communicatively connected to a controller of the system. Further examples of suitable machine learning models may be found in U.S. patent application Ser. No. 17/326,496, filed on May 21, 2021 and incorporated herein by reference.

In one embodiment, a machine learning algorithm may be configured to process data collected from a plurality of sensors in order to calculate a rate of temperature change over time in different configurations. In one embodiment, a system may collect data from one or more of an ultrasonic sensor, an infrared sensor, or a thermistor. In one embodiment, two or more sensors are used positioned at different points in the same room. In one embodiment, one or more of the sensors used may be positioned on a ceiling of the room. A system may for example collect data from three sensors over time when an HVAC system is active and blowing conditioned air out of at least one vent positioned in the same room as the sensors. In one embodiment, an ultrasonic range sensor may be used in conjunction with an infrared temperature sensor, for example to determine if a person walked into the path of the infrared temperature sensor, potentially indicating the presence of an anomalous reading (e.g. body temperature instead of room temperature). In some embodiments, the ultrasonic sensor may prevent false positives on the infrared sensor, or vice-versa.

In some embodiments, one or more barriers as discussed above and shown in FIG. 11A-FIG. 11C may be used. In some embodiments, a system may further collect additional data from some or all of the three sensors when the HVAC system is turned off. The system may then perform a regression on the collected measurements over time, and may incorporate additional factors, for example factors described in U.S. patent application Ser. No. 17/326,496, and may calculate a rate of temperature change over time based on how long the HVAC system is on or off. In some embodiments, a system may use the calculated rate of temperature change to determine how long the HVAC system needs to be active in order to change the temperature of the room by X degrees. In some embodiments, the data may be updated constantly so that the rate of temperature change is accurate for different weather, seasons, occupancy, etc.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. An intelligent air management system, comprising:
an HVAC unit;
a smart duct comprising an electromechanically actuated damper, fluidly connected to the HVAC unit;
a power supply connected to the smart duct;
at least one room sensor positioned in a room, the at least one room sensor comprising a motion sensor, a temperature sensor, a light intensity sensor, a sound sensor, and a CO₂ sensor;
a controller communicatively connected to the smart duct and the at least one room sensor;
a vent fluidly connected to the smart duct and positioned in the room; and
a barrier positioned between the at least one room sensor and the vent, configured to direct air emitted from the vent away from the temperature sensor;
wherein the controller is configured to open and close the electromechanically actuated damper in response to measurements from the at least one room sensor.

2. The intelligent air management system of claim 1, further comprising a supply plenum box and the smart duct is a smart supply duct.

3. The intelligent air management system of claim 1, further comprising a return plenum box and the smart duct is a smart return duct.

4. The intelligent air management system of claim 1, wherein the room sensor further comprises an ultrasonic sensor and an infrared sensor.

5. The intelligent air management system of claim 1, further comprising at least one duct sensor positioned within the duct and communicatively connected to the controller.

6. The intelligent air management system of claim 5, wherein the duct sensor is a smoke sensor, and the damper is configured to close automatically when smoke is detected in the duct.

7. The intelligent air management system of claim 5, wherein the duct sensor is a heat sensor, and the damper is configured to close automatically when a very high temperature is detected in the duct.

8. The intelligent air management system of claim 1, wherein the power supply is a wired electrical power supply or a battery.

9. The intelligent air management system of claim 1, wherein the controller is a thermostat.

10. The intelligent air management system of claim 1, comprising:
a supply plenum box fluidly connected to the HVAC unit;
a return plenum box fluidly connected to the HVAC unit;
a smart supply duct fluidly connected to the supply plenum box and the vent; and
a smart return duct fluidly connected to the return plenum box and the vent;
wherein the vent can serve as a return vent when the smart return duct is open, or as a supply vent when the smart supply duct is open.

11. The intelligent air management system of claim 1, further comprising a VAV air handler.

12. A method of controlling room temperature in a multi-room structure, comprising the steps of:
obtaining a first room temperature measurement from a sensor in a first room;
obtaining a second room temperature measurement from a sensor in a second room;
activating an HVAC unit to change the temperature of air flowing through the HVAC unit;
opening a first damper in a first smart duct fluidly connected to the first room;
closing a second damper in a second smart duct fluidly connected to the second room; and
forcing a quantity of air through the HVAC unit and the first smart duct into the first room, such that the closed second damper blocks substantially all air flow into the second room.

13. The method of claim 12, further comprising the steps of:
obtaining a duct air flow measurement from an air flow sensor positioned within the first smart duct;
comparing the duct air flow measurement to an expected first duct air flow level; and
if the duct air flow measurement is less than the expected first duct air flow level, opening a smart bypass duct fluidly connected to an intake of the HVAC unit.

14. The method of claim 12, wherein the HVAC unit is an air conditioner configured to reduce the temperature of the air passing through it.

15. The method of claim 12, further comprising the steps of:
obtaining a third room temperature measurement from a sensor in a third room;
obtaining a desired threshold air temperature;
activating a fan to move air through an HVAC unit;
opening a third damper in a third smart duct fluidly connected to a third room; and
forcing a quantity of air from the third room through the HVAC unit into the first room when the third room temperature measurement meets the desired threshold air temperature and the first room temperature measurement does not meet the desired threshold air temperature.

16. The method of claim 15, further comprising the steps of activating a cooling element within the HVAC unit to further cool the air;
wherein the desired threshold air temperature is a maximum air temperature.

17. The method of claim 15, further comprising the steps of activating a heating element within the HVAC unit to further heat the air;
wherein the desired threshold air temperature is a minimum air temperature.

18. The method of claim 16, further comprising the steps of:
opening a damper in a bypass duct fluidly connecting a supply side of the HVAC unit to the return side of the HVAC unit; and
flowing a quantity of air through the bypass duct and back through the HVAC unit to be cooled further.

19. The method of claim 17, further comprising the steps of:
opening a damper in a bypass duct fluidly connecting a supply side of the HVAC unit to the return side of the HVAC unit; and
flowing a quantity of air through the bypass duct and back through the HVAC unit to be heated further.

20. A method of controlling room temperature in a room, comprising:
positioning a plurality of room sensors in a room fluidly connected to an HVAC component, each room sensor comprising a temperature sensor;
periodically measuring and recording a temperature measurement from each of the plurality of temperature sensors;
activating the HVAC component, flowing conditioned air into the room;
calculating a rate of change of temperature in the room while the HVAC component is activated;
deactivating the HVAC component, stopping the flow of conditioned air into the room;
calculating a second rate of change of temperature in the room while the HVAC component is deactivated; and
controlling the HVAC component with a calculated model of temperature change, configured to activate the HVAC component for as long as necessary to maintain a set temperature in the room.
